(19) United States
(12) Patent Application Publication
(10) Pub. No.: US 2024/0386405 A1
(43) Pub. Date: Nov. 21, 2024

(54) BILL PROCESSING METHOD AND APPARATUS, ELECTRONIC DEVICE, AND STORAGE MEDIUM

(71) Applicant: Beijing Zitiao Network Technology Co., Ltd, Beijing (CN)

(72) Inventor: Yuchen HE, Beijing (CN)

(21) Appl. No.: 18/787,945

(22) Filed: Jul. 29, 2024

Related U.S. Application Data
(63) Continuation of application No. PCT/CN2023/072007, filed on Jan. 13, 2023.

(30) Foreign Application Priority Data
Jan. 29, 2022 (CN) 202210112781.8

(51) Int. Cl. G06Q 20/10; H04L 51/224

(52) U.S. Cl. CPC G06Q 20/102; H04L 51/224

(57) ABSTRACT

Embodiments of the present disclosure disclose a bill processing method and apparatus, an electronic device, and a storage medium. The method comprises: obtaining, from a target mailbox, target information associated with a bill, wherein the target mailbox is determined on the basis of a first mailbox of a target user, and the target user is a user associated with the bill; extracting key information on the basis of the target information; in response to the fact that the key information satisfies a preset condition, sending a notification message to the target user; and in response to a trigger operation of the target user on a first control in the notification message, allocating a resource corresponding to the bill to the target user.

### CROSS-REFERENCING OF RELEVANT APPLICATIONS

The present application is based on and claims the priority to the International Application No. PCT/CN2023/072007 filed on Jan. 13, 2023 and the CN application Ser. No. 20/221,0112781. 8 filed on Jan. 29, 2022. The disclosure of each of these applications is incorporated herein into the present application as a whole.

### TECHNICAL FIELD

The present disclosure relates to the technical field of information, and in particular, to a bill processing method and apparatus, an electronic device and a storage medium.

### BACKGROUND

In the daily management of companies, there will be various types of bills that need to be reviewed and processed.

The existing bill processing flow is that: a user manually fills in a processing form and submits the processing form to a review department, and colleagues in the review department will pay the user after reviewing and approving the processing form.

### SUMMARY

According to some embodiments of the present disclosure, provided is a bill processing method, including:
acquiring, from a target mailbox, target information associated with a bill, wherein the target mailbox is determined based on a preset mailbox of a target user, and the target user is a user associated with the bill;
extracting key information based on the target information;
in response to the key information meeting a preset condition, sending a notification message to the target user; and
in response to a trigger operation of the target user on a first control in the notification message, allocating a resource corresponding to the bill to the target user.

According to other embodiments of the present disclosure, further provided is a bill processing apparatus, including:
an acquisition module, which is configured to acquire, from a target mailbox, target information associated with a bill, wherein the target mailbox is determined based on a first mailbox of a target user, and the target user is a user associated with the bill;
an extraction module, which is configured to extract key information based on the target information;
a sending module, which is configured to, in response to the key information meeting a preset condition, send a notification message to the target user; and
an allocation module, which is configured to, in response to a trigger operation of the target user on a first control in the notification message, allocate a resource corresponding to the bill to the target user.

According to yet other embodiments of the present disclosure, further provided is an electronic device, including:
one or more processors; and
a storage apparatus, which is configured to store one or more programs;
when the one or more programs are executed by the one or more processors, the one or more processors being caused to implement the bill processing method as described above.

According to yet other embodiments of the present disclosure, further provided is a computer-readable storage medium on which a computer program is stored, the program, when executed by a processor, implementing the bill processing method as described above.

According to yet other embodiments of the present disclosure, further provided is a computer program, including instructions which, when executed by a processor, implement the bill processing method as claimed in any of the preceding embodiments.

### BRIEF DESCRIPTION OF THE DRAWINGS

The above and other features, advantages, and aspects of various embodiments of the present disclosure will become more apparent with reference to the following detailed implementations taken in conjunction with the accompanying drawings. Throughout the accompanying drawings, the same or similar reference numbers refer to the same or similar elements. It is to be understood that the accompanying drawings are schematic and that originals and elements are not necessarily drawn to scale.

FIG. 1 is a schematic diagram of an existing bill processing flow in an embodiment of the present disclosure;

FIG. 2 is a schematic diagram of an improved bill processing flow in an embodiment of the present disclosure;

FIG. 3 is a flowchart of a bill processing method in an embodiment of the present disclosure;

FIG. 4 is a schematic diagram of a display interface of a notification message in an embodiment of the present disclosure;

FIG. 5 is a schematic structural diagram of a bill processing apparatus in an embodiment of the present disclosure; and

FIG. 6 is a schematic structural diagram of an electronic device in an embodiment of the present disclosure.

### DETAILED DESCRIPTION

Embodiments of the present disclosure will be described in more detail below with reference to the accompanying drawings. Although certain embodiments of the present disclosure are shown in the accompanying drawings, it should be understood that the present disclosure may be embodied in various forms and should not be construed as being limited to the embodiments set forth herein, which rather are provided for a more thorough and complete understanding of the present disclosure. It should be understood that the accompanying drawings and embodiments of the present disclosure are for illustrative purposes only and are not intended to limit the scope of protection of the present disclosure.

It should be understood that various steps described in the method implementations of the present disclosure may be executed in different orders and/or in parallel. Furthermore, method embodiments may include additional steps and/or omit performance of illustrated steps. The scope of the present disclosure is not limited in this regard.

As used herein, the term “include” and its variations are open-ended, i.e. “including but not limited to”. The term “based on” means “based at least in part on”. The term “one embodiment” means “at least one embodiment”; the term “another embodiment” means “at least one additional embodiment”; and the term “some embodiments” means “at least some embodiments”. Relevant definitions of other terms will be given in the description below.

It should be noted that concepts such as “first” and “second” mentioned in the present disclosure are only used to distinguish different apparatuses, modules or units, and are not used to limit the order or interdependence of functions performed by these apparatuses, modules or units.

It should be noted that the modifications of “one” and “a plurality of” mentioned in the present disclosure are illustrative rather than restrictive. Those skilled in the art should understand that unless the context clearly indicates otherwise, the modifications should be understood as “one or more”.

The names of messages or information exchanged between a plurality of apparatuses in the implementations of the present disclosure are for illustrative purposes only, and are not used to limit the scope of these messages or information.

Usually, the bill processing flow is that: after obtaining a bill to be processed, a user manually fills in a processing form and then submits the processing form to an approval department for manual approval; after the approval is passed, corresponding resources are allocated to the user, meanwhile the user also needs to post the bill to the processing form and submit the processing form to the finance department. The inventors found that the above processing flow is relatively cumbersome, and the user manually participates in many operations, resulting in low processing efficiency.

Taking the processing of taxi bills as an example, referring to the schematic diagram of an existing bill processing flow as shown in FIG. 1, the processing flow specifically includes: a user taking a taxi—advancing the taxi fare—applying for invoicing—the user filling in the processing form—the financial department performing approval—the user being paid (that is, the user collecting payment) after the approval is passed—the user posting the bill—submitting the processing form again.

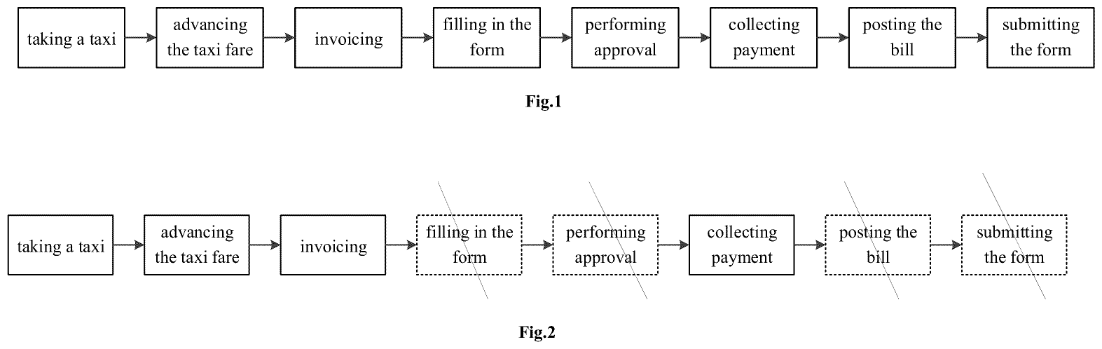

In response to the above problems, an embodiment of the present disclosure provides a bill processing method, aiming to solve the problem of low processing efficiency caused by excessive manual participation in the existing bill processing flow. Taking the processing of taxi bills as an example, referring to the schematic diagram of an improved bill processing flow as shown in FIG. 2, the processing flow specifically includes: a user taking a taxi—advancing the taxi fare-applying for invoicing-collecting payment. Comparing with FIG. 1, it can be determined that four links, i.e., the user filling in the processing form—the financial department performing approval—the user posting the bill—submitting the processing form again are reduced. These four links are automatically completed through automated procedures, which greatly simplifies user operations and improves the processing efficiency.

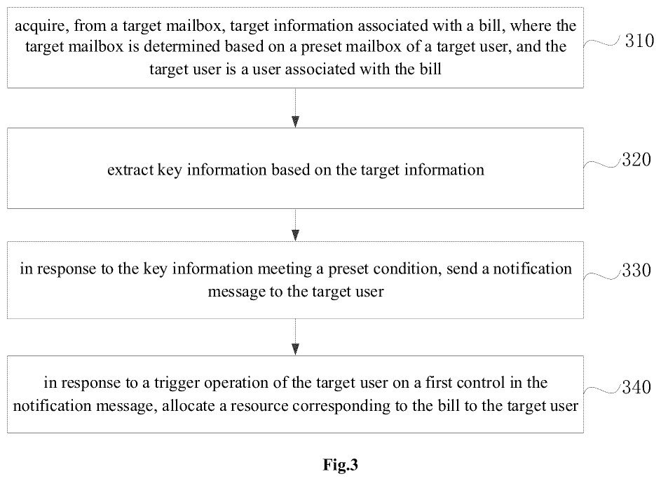

Specifically, FIG. 3 is a flowchart of a bill processing method in an embodiment of the present disclosure. This embodiment can be applied to processing electronic bills, including but not limited to taxi bills and meal bills for team building expenses, etc. The method can be executed by a bill processing apparatus, which can be implemented by means of software and/or hardware and can be configured in an electronic device, such as a server.

As shown in FIG. 3, the method specifically includes the following steps: steps 310-340.

In step 310, target information associated with a bill is acquired from a target mailbox, where the target mailbox is determined based on a first mailbox of a target user, and the target user is a user associated with the bill.

In some embodiments, the target mailbox is the first mailbox, that is, the target mailbox and the first mailbox are the same mailbox. Alternatively, processing is performed based on the first mailbox to obtain the target mailbox.

In some embodiments, a postfix can be added to the address information of the first mailbox to obtain the address information of the target mailbox. Alternatively, address information of another mailbox that has a mapping relationship with the address information of the first mailbox is determined as the address information of the target mailbox.

The target mailbox can be a dedicated mailbox specially used for processing bills, or can be a multi-purpose mailbox.

In some embodiments, the target mailbox being determined based on a first mailbox of a target user includes:
acquiring address information of the first mailbox, changing a part of information in the address information, and using the changed address information as address information of the target mailbox; alternatively,
acquiring address information of the first mailbox, identifying a first information in the address information, determining a second information associated with the first information, and using another address information containing the second information as address information of the target mailbox.

In some embodiments, the method also includes: before acquiring, from a target mailbox, target information associated with a bill,
in response to an order status of the target user being completed, receiving an email sent by a third-party platform, the bill is contained in the email.

Specifically, for example, in an application scenario of taking a taxi on an online car-hailing platform for official business, when the order status of the taxi order of the target user is completed, that is, when the target user has arrived at the destination and completed the payment of the taxi fare, the target user applies for a taxi bill through the online car-hailing platform (i.e., a third-party platform), and after receiving the application from the target user, the online car-hailing platform sends an email to the target mailbox filled in by the target user, the email contains the taxi bill.

In some embodiments, the acquiring, from a target mailbox, target information associated with a bill includes:
parsing an unread email in the target mailbox to acquire a target email whose sending address is a preset address; and acquiring an attachment in the target email, and determining a content of the attachment as the target information. The preset address is usually the email address of the third-party platform. If the target mailbox is a dedicated mailbox specially used for bill processing, then all the mails in the target mailbox are bill-related mails. By parsing an unread email in the target mailbox to acquire a target email whose sending address is the preset address, then acquiring an attachment in the target email and determining the content of the attachment as the target information, the purpose of efficiently acquiring the target information associated with the latest bill to be processed can be achieved, and the effect of rapid processing can be obtained.

In some embodiments, the method also includes: after acquiring, from a target mailbox, target information associated with a bill to be processed, marking the target email as a read email, so as to prevent interference with subsequent bill processing and achieve the purpose of improving the efficiency of obtaining target information, thereby improving the efficiency of bill processing.

In step 320, key information is extracted based on the target information.

Usually, the target information is in pdf format or picture format.

In some embodiments, the extracting key information based on the target information includes:

extracting key information from the target information by means of an optical character recognition (OCR) algorithm. OCR is a technology that converts text on images into computer-editable text content. Key information can be acquired from images by means of OCR technology.

Further, in some embodiments, in order to improve the efficiency of bill processing and the processing accuracy, the method also includes: before extracting key information based on the target information:
determining whether a quantity of the target information is a first preset quantity, and if the quantity of the target information is the first preset quantity, extracting key information based on the target information. For example, when it is determined that the quantity of attachments included in an unread email in the target mailbox is a first preset quantity, it is determined that the quantity of the target information is the first preset quantity. At this time, the operation of “extracting key information based on the target information” in the above step 320 is continued; otherwise, the bill processing flow ends, and the operation of “extracting key information based on the target information” in the above step 320 is not continued. The first preset quantity is set based on application scenarios and personalized requirements of various bill processing units. By setting the first preset quantity, a personalized bill processing solution for a specific application scenario and various bill processing units can be realized.

Alternatively, determining whether a quantity of types of the target information is a second preset quantity, and if the quantity of types of the target information is the second preset quantity, extracting key information based on the target information.

For example, in an application scenario of taking a taxi on an online car-hailing platform, when the type of target information is an itinerary and an invoice that matches the itinerary, the operation of “extracting key information based on the target information” in the above step 320 is continued; otherwise, the bill processing flow ends, and the above step 320 is not continued. A personalized bill processing solution for a specific application scenario is realized.

Generally speaking, the target information includes at least one first type file and at least one second type file, and the first type file and the second type file correspond one to one. For example, in an application scenario of taking a taxi on an online car-hailing platform, the target information includes an itinerary and an invoice that matches the itinerary. The key information may include: resource information of the bill (such as the invoice amount); at least one of a bill code and a bill number; and at least one of a carrier type (such as luxury, economy, comfort, etc. types given by the online car-hailing platform), departure time and location information.

In step 330, in response to the key information meeting a preset condition, a notification message is sent to the target user.

In some embodiments, the in response to the key information meeting a preset condition, sending a notification message to the target user includes:
if first key information in the first type file matches second key information in the corresponding second type file, sending the notification message to the target user.

For example, in an application scenario of taking a taxi on an online car-hailing platform, the target information includes an itinerary and an invoice that matches the itinerary. When the taxi fare recorded in the itinerary is the same as the taxi fare recorded in the invoice, the notification message is sent to the target user; otherwise, the bill processing flow ends, and the notification message is not sent to the target user, so as to improve the accuracy of bill processing.

Further, in some embodiments, the in response to the key information meeting a preset condition, sending a notification message to the target user includes:
determining, based on the key information, whether the bill is a first type of bill by connecting to a preset website; and if the bill is the first type of bill, sending a notification message to the target user. The first type of bill is, for example, an unprocessed bill. Taking the bill as an invoice as an example, the first type of bill refers to an invoice that has not been reimbursed and is regular rather than forged. By verifying the bill, the accuracy and standardization of bill processing can be improved.

In step 340, in response to a trigger operation of the target user on a first control in the notification message, a resource corresponding to the bill is allocated to the target user.

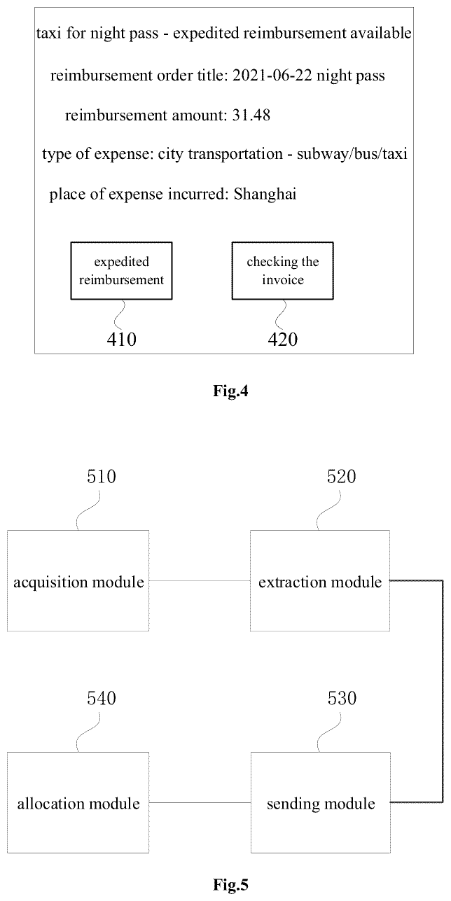

In some embodiments, referring to the schematic diagram of a display interface of a notification message as shown in FIG. 4, the schematic diagram includes a processing summary “taxi for night pass-expedited processing available”, a processing order title “night pass on *year *month *day”; processing amount: **; the type of expense: city transportation-subway/bus/taxi; the place of expense incurred: * city; a first control 410 and a second control 420. When the target user receives the notification message and triggers the first control 410, the bill processing can be completed, and the bill processing system automatically allocates a resource corresponding to the bill to the target user. When the target user triggers the second control 420, the bill information is displayed to facilitate the user's viewing. When the user confirms that the bill is correct, the bill processing can be completed by triggering the first control 410. The operation is simple, the processing is efficient, and the user can be provided with a better user experience.

In some embodiments, the method also includes: the key information including a carrier type, and before allocating a resource corresponding to the bill to the target user,
if the carrier type is a type other than a preset type, determining, based on a preset algorithm and according to the key information, a target resource corresponding to the carrier type being the preset type; and determining the target resource as a resource that is corresponding to the bill and allocated to the target user. For example, in an application scenario of taking a taxi on an online car-hailing platform for business, some bill processing units provide for reimbursement of taxi fares incurred only for rides in “economy” cars; in the case of rides in “luxury” cars, only taxi fares comparable to those incurred in “economy” cars are reimbursed, but not in full. For example, a target user pays 50 yuan for a taxi ride from A to B in a “luxury” car, and 40 yuan for a taxi ride from A to B in an “economy” car. Assuming that the target user takes in a “luxury” car, when processing the bill generated from the taxi order, the target user will only be reimbursed 40 yuan for the taxi fare, but not the full 50 yuan.

In addition to the limitation on the carrier type, some bill processing units also have other limitations, such as the departure location needs to be within a set area, and/or the city of the taxi needs to be a preset city or match the city filled out in a business trip application form, and/or the date of the taxi needs to match the date filled out in the business trip application form, etc.

Therefore, before sending a notification message to the target user, it is necessary to determine, based on the key information, whether a preset condition is met. If the preset condition is met, the operation of sending a notification message to the target user is performed; otherwise, the bill processing flow is exited. The accuracy of bill processing can be improved, and different personalized bill processing solutions can be realized by setting preset conditions.

Further, in order to improve the standardization and degree of automation of the bill processing flow, the method also includes: after the trigger operation of the user on a first control in the notification message,
configuring the extracted key information into a preset template to generate an approval file, and initiating an approval process based on the approval file; in response to the initiation of the approval process, automatically passing the approval process, and allocating a resource corresponding to the bill to the target user.

According to the bill processing method provided in an embodiment of the present disclosure, target information associated with a bill to be processed is received by means of a target mailbox pre-agreed between a user and a processing unit, which prevents the user's manual operations of downloading and uploading bills, simplifies the user's manual operations in the processing flow, and is conducive to improving the processing efficiency and user experience; key information is automatically extracted and matched with a processing policy stipulated by the bill processing unit, bill processing is automatically completed under the premise of complying with the processing policy stipulated by the bill processing unit, and the bill processing is completed by sending a notification message to the target user, upon receiving a confirmation instruction from the target user, which can improve the accuracy of bill processing; and an approval file is automatically generated, an approval process is automatically initiated, and a resource corresponding to the bill is allocated to the target users after the approval passes, which improves the degree of automation and processing efficiency of bill processing, and saves labor costs.

FIG. 5 is a schematic structural diagram of a bill processing apparatus in some embodiments of the present disclosure. The bill processing apparatus provided in the embodiments of the present disclosure can be configured in a server. The bill processing apparatus specifically includes: an acquisition module 510, an extraction module 520, a sending module 530, and an allocation module 540.

The acquisition module 510 is configured to acquire, from a target mailbox, target information associated with a bill, where the target mailbox is determined based on a first mailbox of a target user, and the target user is a user associated with the bill. The extraction module 520 is configured to extract key information based on the target information. The sending module 530 is configured to, in response to the key information meeting a preset condition, send a notification message to the target user. The allocation module 540 is configured to, in response to a trigger operation of the target user on a first control in the notification message, allocate a resource corresponding to the bill to the target user.

In some embodiments, the bill processing apparatus also includes: an email address processing module, which is configured to acquire address information of the first mailbox, change a part of information in the address information, and use the changed address information as address information of the target mailbox; alternatively,
acquire address information of the first mailbox, identify a first information in the address information, determine a second information associated with the first information, and use another address information containing the second information as address information of the target mailbox.

In some embodiments, the bill processing apparatus also includes: a receiving module, which is configured to, before acquiring, from a target mailbox, target information associated with a bill, in response to an order status of the target user being completed, receive an email sent by a third-party platform, the bill is contained in the email.

In some embodiments, the acquisition module 510 includes: a parsing unit, which is configured to parse an unread email in the target mailbox to acquire a target email whose sending address is a preset address; and a determination unit, which is configured to acquire an attachment in the target email, and determining a content of the attachment as the target information.

In some embodiments, the bill processing apparatus also includes: a display module, which is configured to, in response to a trigger operation of the target user on a second control in the notification message, display the bill information.

In some embodiments, the bill processing apparatus also includes: a determination module, which is configured to determine whether a quantity of the target information is a first preset quantity, and in response to the quantity of the target information is the first preset quantity, extract key information based on the target information; alternatively, determine whether a quantity of types of the target information is a second preset quantity, and in response to the quantity of types of the target information is the second preset quantity, extract key information based on the target information.

In some embodiments, the target information includes at least one first type file and at least one second type file, the first type file and the second type file corresponding one to one. The sending module 530 is specifically configured to, in response to first key information in the first type file matches second key information in the corresponding second type file, send the notification message to the target user.

In some embodiments, the key information includes: at least one of a bill code and a bill number, at least one of a carrier type, departure time and location information, and resource information of the bill.

In some embodiments, the bill processing apparatus also includes: a conversion module, which is s configured to, before allocating a resource corresponding to the bill to the target user, in response to the carrier type is a type other than a preset type, determine, based on a preset algorithm and according to the key information, a target resource corresponding to the carrier type being the preset type; and determine the target resource as a resource that is corresponding to the bill and allocated to the target user.

In some embodiments, the sending module 530 is specifically configured to: determine, based on the key information, whether the bill is a first type of bill by connecting to a preset website; and in response to the bill is the first type of bill, send a notification message to the target user.

In some embodiments, the bill processing apparatus also includes: a configuration module, which is configured to, after the trigger operation of the user on a first control in the notification message, configure the extracted key information into a preset template to generate an approval file, and initiate an approval process based on the approval file.

In some embodiments, the bill processing apparatus also includes: an approval module, which is configured to, in response to the initiation of the approval process, automatically pass the approval process, and allocate a resource corresponding to the bill to the target user.

According to the bill processing apparatus provided in the embodiments of the present disclosure, by means of a technical means of acquiring, from a target mailbox, target information associated with a bill, where the target mailbox is determined based on a preset mailbox of a target user, and the target user is a user associated with the bill; extracting key information based on the target information; in response to the key information meeting a preset condition, sending a notification message to the target user; and in response to a trigger operation of the target user on a first control in the notification message, allocating a resource corresponding to the bill to the target user, the process of automatic approval is realized, the degree of automation and processing efficiency of the bill processing flow are improved, and labor costs are saved.

The bill processing apparatus provided in the embodiments of the present disclosure can execute the steps performed by a client or server in the bill processing method provided in the method embodiments of the present disclosure. The specific execution steps and beneficial effects will not be described again here.

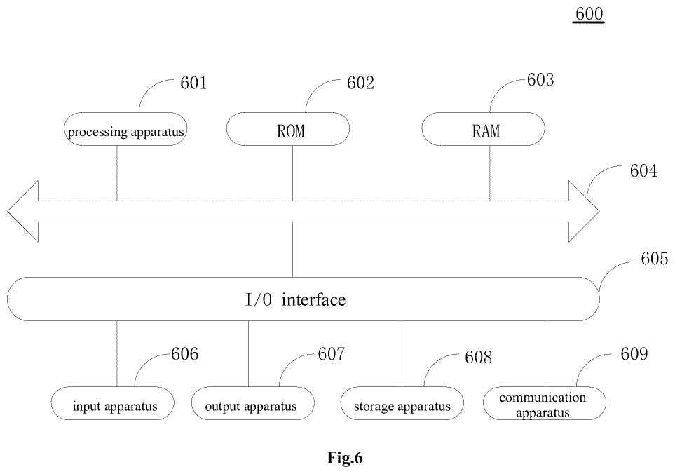

FIG. 6 is a schematic structural diagram of an electronic device in an embodiment of the present disclosure. Referring specifically to FIG. 6 below, a schematic structural diagram suitable for implementing an electronic device 600 in an embodiment of the present disclosure is shown. The electronic device 600 in an embodiment of the present disclosure may include, but is not limited to, mobile terminals such as mobile phone, laptop, digital broadcast receiver, PDA (personal digital assistants), PAD (pads), PMP (portable multimedia players), vehicle-mounted terminal (e.g., vehicle-mounted navigation terminals), and wearable electronic device, as well as fixed terminals such as digital TV, desktop computer, and smart home device. The electronic device shown in FIG. 6 is only an example and should not impose any limitations on the functions and scope of use of the embodiments of the present disclosure.

As shown in FIG. 6, the electronic device 600 may include a processing apparatus (e.g., a central processing unit, a graphics processor, etc.) 601, which may perform various appropriate actions and processes according to programs stored in a read-only memory (ROM) 602 or programs loaded from the storage apparatus 608 into a random access memory (RAM) 603, so as to implement the method of the embodiments described in the present disclosure. Various programs and data required for the operation of the electronic device 600 are also stored in the RAM 603. The processing apparatus 601, ROM 602 and RAM 603 are connected to each other via a bus 604. An input/output (I/O) interface 605 is also connected to the bus 604.

Generally, the following apparatuses may be connected to the I/O interface 605: an input apparatus 606 including, for example, a touch screen, a touch pad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow wireless or wired communication between the electronic device 600 and other devices, so as to exchange data. Although FIG. 6 illustrates the electronic device 600 with various apparatuses, it should be understood that implementation or availability of all illustrated apparatuses is not required. More or fewer apparatuses may alternatively be implemented or provided.

In particular, according to the embodiments of the present disclosure, the processes described above with reference to the flowcharts may be implemented as computer software programs. For example, the embodiments of the present disclosure include a computer program product, which includes a computer program carried on a non-transitory computer-readable medium, the computer program containing program code for executing the method shown in the flowcharts, thereby implementing the bill processing method described above. In such embodiments, the computer program may be downloaded and installed from the network by means of the communication apparatus 609, or installed from the storage apparatus 608, or installed from the ROM 602. When the computer program is executed by the processing apparatus 601, the above functions defined in the method in the embodiments of the present disclosure are performed.

It should be noted that the computer-readable medium mentioned above in the present disclosure may be a computer-readable signal medium or a computer-readable storage medium, or any combination of the above two. A computer-readable storage medium may be, for example, but is not limited to, an electrical, magnetic, optical, electromagnetic, infrared, or semiconductor system, apparatus or device, or any combination thereof. More specific examples of a computer-readable storage medium may include, but are not limited to: an electrical connection having one or more wires, a portable computer disk, a hard drive, a random access memory (RAM), a read-only memory (ROM), an erasable programmable read-only memory (EPROM or flash memory), fiber optics, a portable compact disk read-only memory (CD-ROM), an optical storage device, a magnetic storage device, or any suitable combination of the above. In the present disclosure, a computer-readable storage medium may be any tangible medium that contains or stores a program for use by or in combination with an instruction execution system, apparatus, or device. Moreover, in the present disclosure, a computer-readable signal medium may include a data signal propagated in a baseband or as part of a carrier wave, carrying computer-readable program code therein. Such propagated data signals may many forms, including but not limited to electromagnetic signals, optical signals, or any suitable combination of the above. A computer-readable signal medium may also be any computer-readable medium other than the computer-readable storage medium, and can send, propagate, or transmit a program for use by or in combination with an instruction execution system, apparatus, or device. Program code embodied on a computer-readable medium may be transmitted using any suitable medium, including but not limited to: a wire, an optical cable, RF (radio frequency), etc., or any suitable combination of the above.

In some implementations, a client and a server can communicate using any currently known or future developed network protocol such as HTTP (HyperText Transfer Protocol), and can interconnect with digital data communication (e.g., a communications network) in any form or medium. Examples of communication networks include local area networks (“LAN”), wide area networks (“WAN”), networks of network (e.g., the Internet), and end-to-end networks (e.g., ad hoc end-to-end networks), as well as any currently known or future developed networks.

The above computer-readable medium may be contained in the above electronic device, or may also exist independently without being assembled into the electronic device.

The above computer-readable medium carries one or more programs. When the above one or more programs are executed by the electronic device, the electronic device is caused to: acquire, from a target mailbox, target information associated with a bill, where the target mailbox is determined based on a first mailbox of a target user, and the target user is a user associated with the bill; extract key information based on the target information; in response to the key information meeting a preset condition, send a notification message to the target user; and in response to a trigger operation of the target user on a first control in the notification message, allocate a resource corresponding to the bill to the target user.

In some embodiments, when the above one or more programs are executed by the electronic device, the electronic device may also perform other steps described in the above embodiments.

Computer program code for performing the operations of the present disclosure may be written in one or more programming languages, or combinations thereof, including, but not limited to, object-oriented programming languages-such as Java, Smalltalk, C++, and conventional procedural programming languages-such as “C” or similar programming languages. The program code may execute entirely on the user's computer, partly on the user's computer, as a stand-alone software package, partly on the user's computer and partly on a remote computer, or entirely on the remote computer or server. In situations involving remote computers, the remote computers can be connected to the user's computer via any kind of network, including a local area network (LAN) or a wide area network (WAN), or can be connected to external computers (e.g., by using an Internet service provider to connect via the Internet).

The flowcharts and block diagrams in the figures illustrate the architecture, functionality and operations of possible implementations of the system, method, and computer program product according to various embodiments of the present disclosure. In this regard, each block in the flowcharts or block diagrams may represent a module, segment, or portion of code that contains one or more executable instructions that implement specified logic functions. It should also be noted that, in some alternative implementations, the functions noted in the blocks may also occur out of the order noted in the figures. For example, two blocks shown one after another may actually execute substantially in parallel, or may sometimes execute in the reverse order, depending on the functionality involved. It will also be noted that each block of the block diagrams and/or flowcharts, and combinations of blocks in the block diagrams and/or flowcharts can be implemented by dedicated hardware-based systems that perform the specified functions or operations, or can be implemented using a combination of dedicated hardware and computer instructions.

The involved units described in the embodiments of the present disclosure can be implemented in software or hardware. The name of a unit does not constitute a limitation on the unit itself under certain circumstances.

The functions described above herein may be performed, at least in part, by one or more hardware logic components. For example, and without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatuses or devices, or any suitable combination of the above. More specific examples of a machine-readable storage medium would include an electrical connection based on one or more wires, a portable computer disk, a hard drive, a random access memory (RAM), a read-only memory (ROM), an erasable programmable read-only memory (EPROM or flash memory), fiber optics, a portable compact disk read-only memory (CD-ROM), an optical storage device, a magnetic storage device, or any suitable combination of the above.

According to some embodiments of the present disclosure, the present disclosure provides a bill processing method, including: acquiring, from a target mailbox, target information associated with a bill, where the target mailbox is determined based on a first mailbox of a target user, and the target user is a user associated with the bill; extracting key information based on the target information; in response to the key information meeting a preset condition, sending a notification message to the target user; and in response to a trigger operation of the target user on a first control in the notification message, allocating a resource corresponding to the bill to the target user.

According to some embodiments of the present disclosure, the target mailbox being determined based on a first mailbox of a target user includes: acquiring address information of the first mailbox, changing a part of information in the address information, and using the changed address information as address information of the target mailbox; alternatively, acquiring address information of the first mailbox, identifying a first information in the address information, determining a second information associated with the first information, and using another address information containing the second information as address information of the target mailbox.

According to some embodiments of the present disclosure, the method also includes: before acquiring, from a target mailbox, target information associated with a bill, in response to an order status of the target user being completed, receiving an email sent by a third-party platform, the bill is contained in the email.

According to some embodiments of the present disclosure, the acquiring, from a target mailbox, target information associated with a bill includes: parsing an unread email in the target mailbox to acquire a target email whose sending address is a preset address; and acquiring an attachment in the target email, and determining a content of the attachment as the target information.

According to some embodiments of the present disclosure, the method also includes: in response to a trigger operation of the target user on a second control in the notification message, displaying the bill information.

According to some embodiments of the present disclosure, the method also includes: before extracting key information based on the target information, determining whether a quantity of the target information is a first preset quantity, and in response to the quantity of the target information is the first preset quantity, extracting key information based on the target information; alternatively, determining whether a quantity of types of the target information is a second preset quantity, and in response to the quantity of types of the target information is the second preset quantity, extracting key information based on the target information.

According to some embodiments of the present disclosure, the target information includes at least one first type file and at least one second type file, the first type file and the second type file corresponding one to one, and the in response to the key information meeting a preset condition, sending a notification message to the target user includes: if first key information in the first type file matches second key information in the corresponding second type file, sending the notification message to the target user.

According to some embodiments of the present disclosure, the key information includes: at least one of a bill code and a bill number, at least one of a carrier type, departure time and location information, and resource information of the bill.

According to some embodiments of the present disclosure, the key information includes a carrier type, and the method also includes: before allocating a resource corresponding to the bill to the target user, in response to the carrier type is a type other than a preset type, determining, based on a preset algorithm and according to the key information, a target resource corresponding to the carrier type being the preset type; and determining the target resource as a resource that is corresponding to the bill and allocated to the target user.

According to some embodiments of the present disclosure, the in response to the key information meeting a preset condition, sending a notification message to the target user includes: determining, based on the key information, whether the bill is a first type of bill by connecting to a preset website; and in response to the bill is the first type of bill, sending a notification message to the target user.

According to some embodiments of the present disclosure, the method also includes: after the trigger operation of the user on a first control in the notification message, configuring the extracted key information into a preset template to generate an approval file, and initiating an approval process based on the approval file.

According to some embodiments of the present disclosure, the method also includes: in response to the initiation of the approval process, automatically passing the approval process, and allocating a resource corresponding to the bill to the target user.

According to some embodiments of the present disclosure, provided is a bill processing apparatus, including: an acquisition module, which is configured to acquire, from a target mailbox, target information associated with a bill, where the target mailbox is determined based on a first mailbox of a target user, and the target user is a user associated with the bill; an extraction module, which is configured to extract key information based on the target information; a sending module, which is configured to, in response to the key information meeting a preset condition, send a notification message to the target user; and an allocation module, which is configured to, in response to a trigger operation of the target user on a first control in the notification message, allocate a resource corresponding to the bill to the target user.

According to some embodiments of the present disclosure, provided is an electronic device, including:
one or more processors; and
a memory, which is configured to store one or more programs;
when the one or more programs are executed by the one or more processors, the one or more processors being caused to implement the bill processing method as provided in any one of the present disclosure.

According to some embodiments of the present disclosure, provided is a computer-readable storage medium on which a computer program is stored, the program, when executed by a processor, implementing the bill processing method as provided in any one of the present disclosure.

According to some embodiments of the present disclosure, provided is a computer program, including instructions which, when executed by a processor, implement the bill processing method as claimed in any of the preceding embodiments.

The above descriptions are only preferred embodiments of the present disclosure and an illustration of the technical principles applied. Those skilled in the art should understand that the scope of disclosure involved in the present disclosure is not limited to technical solutions formed by particular combinations of the above technical features, but should also cover other technical solutions formed by any combination of the above technical features or their equivalent features without departing from the above disclosed concept, for example, a technical solution formed by replacing the above features with technical features with similar functions disclosed (but not limited to) in the present disclosure.

Furthermore, although various operations are depicted in a specific order, this should not be understood as requiring that these operations be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in a plurality of embodiments separately or in any suitable sub-combination.

Although the present subject matter has been described in language specific to structural features and/or methodological acts, it should be understood that the subject matter defined in the appended claims is not necessarily limited to the specific features or acts described above. Rather, the specific features and acts described above are merely example forms of implementing the claims.

What is claimed is:

1. A bill processing method, comprising:
acquiring, from a target mailbox, target information associated with a bill, wherein the target mailbox is determined based on a preset mailbox of a target user, and the target user is a user associated with the bill;
extracting key information based on the target information;
in response to the key information meeting a preset condition, sending a notification message to the target user; and
in response to a trigger operation of the target user on a first control in the notification message, allocating a resource corresponding to the bill to the target user.

2. The bill processing method according to claim 1, wherein the target mailbox being determined based on a first mailbox of a target user comprises:
acquiring address information of the first mailbox, changing a part of information in the address information, and using the changed address information as the address information of the target mailbox; or
acquiring address information of the first mailbox, identifying a first information in the address information, determining a second information associated with the first information, and using another address information containing the second information as address information of the target mailbox.

3. The bill processing method according to claim 1, further comprising: before acquiring, from a target mailbox, target information associated with a bill,
in response to an order status of the target user being completed, receiving an email sent by a third-party platform, the bill is contained in the email.

4. The bill processing method according to claim 1, wherein the acquiring, from a target mailbox, target information associated with a bill comprises:
parsing an unread email in the target mailbox to acquire a target email whose sending address is a preset address; and
acquiring an attachment in the target email, and determining a content of the attachment as the target information.

5. The bill processing method according to claim 1, further comprising:
in response to a trigger operation of the target user on a second control in the notification message, displaying the bill information.

6. The bill processing method according to claim 1, further comprising: before extracting key information based on the target information,
determining whether a quantity of the target information is a first preset quantity, and in response to the quantity of the target information is the first preset quantity, extracting key information based on the target information; or
determining whether a quantity of types of the target information is a second preset quantity, and in response to the quantity of types of the target information is the second preset quantity, extracting key information based on the target information.

7. The bill processing method according to claim 1, wherein the target information comprises at least one first type file and at least one second type file, the first type file and the second type file corresponding one to one, and the in response to the key information meeting a preset condition, sending a notification message to the target user comprises:
in response to first key information in the first type file matches second key information in the corresponding second type file, sending the notification message to the target user.

8. The bill processing method according to claim 1, wherein the key information comprises: at least one of a bill code and a bill number, at least one of a carrier type, departure time and location information, and resource information of the bill.

9. The bill processing method according to claim 1, wherein the key information comprises a carrier type, and the method further comprises: before allocating a resource corresponding to the bill to the target user,
in response to the carrier type is a type other than a preset type, determining, based on a preset algorithm and according to the key information, a target resource corresponding to the carrier type being the preset type; and
determining the target resource as a resource that is corresponding to the bill and allocated to the target user.

10. The bill processing method according to claim 1, wherein the in response to the key information meeting a preset condition, sending a notification message to the target user comprises:
determining, based on the key information, whether the bill is a first type of bill by connecting to a preset website; and
in response to the bill is the first type of bill, sending a notification message to the target user.

11. The bill processing method according to claim 1, further comprising: after the trigger operation of the user on a first control in the notification message,
configuring the extracted key information into a preset template to generate an approval file, and initiating an approval process based on the approval file.

12. The bill processing method according to claim 11, further comprising:
in response to the initiation of the approval process, automatically passing the approval process, and allocating a resource corresponding to the bill to the target user.

13. An electronic device, comprising:
one or more processors; and
a storage apparatus, which is configured to store one or more programs;
in response to the one or more programs are executed by the one or more processors, the one or more processors is caused to implement the following operations:
acquiring, from a target mailbox, target information associated with a bill, wherein the target mailbox is determined based on a preset mailbox of a target user, and the target user is a user associated with the bill;
extracting key information based on the target information;
in response to the key information meeting a preset condition, sending a notification message to the target user; and
in response to a trigger operation of the target user on a first control in the notification message, allocating a resource corresponding to the bill to the target user.

14. A non-transitory computer-readable storage medium on which a computer program is stored, wherein the program, when executed by a processor, implements the following operations:
acquiring, from a target mailbox, target information associated with a bill, wherein the target mailbox is determined based on a preset mailbox of a target user, and the target user is a user associated with the bill;
extracting key information based on the target information;
in response to the key information meeting a preset condition, sending a notification message to the target user; and
in response to a trigger operation of the target user on a first control in the notification message, allocating a resource corresponding to the bill to the target user.

15. The electronic device according to claim 13, wherein the target mailbox being determined based on a first mailbox of a target user comprises:
acquiring address information of the first mailbox, changing a part of information in the address information, and using the changed address information as the address information of the target mailbox; or
acquiring address information of the first mailbox, identifying a first information in the address information, determining a second information associated with the first information, and using another address information containing the second information as address information of the target mailbox.

16. The electronic device according to claim 13, wherein in response to the one or more programs are executed by the one or more processors, the one or more processors is caused to further implement the following operations: before acquiring, from a target mailbox, target information associated with a bill,
in response to an order status of the target user being completed, receiving an email sent by a third-party platform, the bill is contained in the email.

17. The electronic device according to claim 13, wherein the acquiring, from a target mailbox, target information associated with a bill comprises:
parsing an unread email in the target mailbox to acquire a target email whose sending address is a preset address; and
acquiring an attachment in the target email, and determining a content of the attachment as the target information.

18. The non-transitory computer-readable storage medium according to claim 14, wherein the target mailbox being determined based on a first mailbox of a target user comprises:
acquiring address information of the first mailbox, changing a part of information in the address information, and using the changed address information as the address information of the target mailbox; or
acquiring address information of the first mailbox, identifying a first information in the address information, determining a second information associated with the first information, and using another address information containing the second information as address information of the target mailbox.

19. The non-transitory computer-readable storage medium according to claim 14, wherein the program, when executed by the processor, further implements the following operations: before acquiring, from a target mailbox, target information associated with a bill,
in response to an order status of the target user being completed, receiving an email sent by a third-party platform, the bill is contained in the email.

20. The non-transitory computer-readable storage medium according to claim 14, wherein the acquiring, from a target mailbox, target information associated with a bill comprises:
parsing an unread email in the target mailbox to acquire a target email whose sending address is a preset address; and
acquiring an attachment in the target email, and determining a content of the attachment as the target information.
